(19) United States
(12) Patent Application Publication
(10) Pub. No.: US 2010/0153095 A1
(43) Pub. Date: Jun. 17, 2010

(54) Virtual Pet Chatting System, Method, and Virtual Pet Question and Answer Server

(75) Inventors: Haisong Yang, Shenzhen City (CN); Yunfeng Liu, Shenzhen City (CN)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: Tencent Technology (Shenzhen) Company Ltd., Shenzhen (CN)

(21) Appl. No.: 12/708,492

(22) Filed: Feb. 18, 2010

Related U.S. Application Data
(63) Continuation of application No. PCT/CN2008/071874, filed on Aug. 5, 2008.

(30) Foreign Application Priority Data
Sep. 1, 2007 (CN) 200710076901.9

(51) Int. Cl. G06F 17/27; G06F 3/048

(52) U.S. Cl. 704/9; 715/758

(57) ABSTRACT

A virtual pet chatting system includes a virtual pet client unit, a virtual pet data maintaining unit as well as a questioning and answering unit. A virtual pet chatting method includes: sending, by a first virtual pet, a natural language question to a second virtual pet; and generating, by the second virtual pet, a natural language response sentence according to the natural language question, after understanding the natural language and performing reasoning taking into account attributes of a virtual pet. A virtual pet questioning and answering server includes a natural language understanding module and a response sentence generating module.

This application claims the benefit of Chinese Patent Application No. 2007100769019 filed on Sep. 1, 2007, and entitled “Virtual Pet Chatting System, Method and Virtual Pet Questioning and Answering Server”. The disclosure of the above Chinese patent application is incorporated in the instant application by reference.

### TECHNICAL FIELD

The present invention relates to Computer and Communication technologies, and more particularly, to a virtual pet chatting system, method and virtual pet questioning and answering server.

### BACKGROUND OF THE INVENTION

In recent years, virtual pet becomes an increasingly popular recreational game, loved more and more by the Internet users. The virtual pet has a cartoon and virtual figure. Some intelligent virtual pets even have some characters and are very lovable. A user of the virtual pet may obtain recreational experience through questioning and answering actions, such as “feeding” the virtual pet or playing a game with the virtual pet.

Although, at present, the virtual pet has certain intelligence, but the intelligence is limited to the questioning and answering between the virtual pet and the master thereof, which is performed by the virtual pet master through simply clicking the mouse or set command symbols. The questioning and answering can not be performed among multiple virtual pets, not to mention dialogs may be performed among the multiple virtual pets in the form of natural language. Thus, current virtual pet system is far from that expected by the people.

At present, the interactive mode among the virtual pets is relatively single. That is to say, a developer of the virtual pet game sets a dialog, and the set dialog is played when two virtual pets encounter. Although the user can obtain some recreational experience from such interactive mode, such interactive mode is far from satisfying deeper requirements of the user.

Many users expect that virtual pets fed by the users may perform intelligent dialogs using the natural language with each other, or the virtual pets fed by the users may perform the intelligent dialogs using the natural language with those fed by other buddies, and the users may obtain the recreational experience from watching the automatic dialogs among the virtual pets.

Further, in order to get to know net friends as well as people of the same interests and hobbies, the users usually turn to a currently fashionable social website or social network community. Thus, the progress to know each other is too direct and boring, which does not satisfy special requirements of some users.

### SUMMARY OF THE INVENTION

Embodiments of the present invention provide a virtual pet chatting system, method and a virtual pet questioning and answering server, by which the virtual pets may communicate with each other using the natural language based on the natural language processing method and combining the automatic questioning and answering technologies.

An embodiment of the present invention provides a virtual pet questioning and answering server, including:

a natural language understanding module, configured to perform understanding processing for a natural language question sent by a first virtual pet, send a processing result; and a response sentence generating module, configured to receive the processing result from the natural language understanding module, perform reasoning according to the processing result and an attribute of a virtual pet, and generate a natural language response sentence for a second virtual pet.

Preferably, the natural language understanding module is a sentence understanding engine; and the response sentence generating module is a reasoning engine.

Preferably, the virtual pet questioning and answering server further includes: a knowledge library, configured to save a great deal of needed reasoning knowledge used for natural language reasoning as well as questioning and answering, in a form of questioning and answering sentence pair and adopting a specific format suitable for the reasoning, to provide accessing and using for the reasoning engine.

Preferably, the natural language understanding processing performed by the sentence understanding engine includes: segmenting a word, extracting a sentence trunk, determining a sentence type and determining atopic

Preferably, the reasoning engine is further configured to generate the natural language response sentence corresponding to the input natural language question, according to the processing result of the sentence understanding engine, the reasoning knowledge, pet attributes and pet master attributes saved in the knowledge library.

Preferably, the questioning and answering sentence pair in the knowledge library includes: a specific relevant field, and the relevant filed is replaced with data of the corresponding attribute of the virtual pet when the reasoning engine generating the final response, e.g., generating the natural language response sentence for the second virtual pet.

Another embodiment of the present invention provides a virtual pet chatting system, includes: a virtual pet client unit, a virtual pet data maintaining unit and a questioning and answering unit; in which

the virtual pet client unit, which connects with the virtual pet data maintaining unit, configured to send a natural language question of a first virtual pet to the virtual pet data maintaining unit, and display a natural language response sentence of a second virtual pet returned by the virtual pet data maintaining unit; and

the virtual pet data maintaining unit, which connects with the virtual pet client unit as well as the questioning and answering unit, configured to save and manage attributes of virtual pets, forward the natural language question of the first virtual pet sent by the virtual pet client unit to the questioning and answering unit, and return the natural language response sentence of the second virtual pet which is generated by the questioning and answering unit to the virtual pet client unit; and the questioning and answering unit, which connects with the virtual pet data maintaining unit, configured to perform natural language understanding and reasoning for the natural language question of the first virtual pet sent by the virtual pet data maintaining unit, and generate the natural language response sentence for the second virtual pet.

The virtual pet client unit may be a virtual pet client, configured to send received operation information performed by a user for a virtual pet and/or a chatting initiation sentence, e.g., the natural language question of the first virtual pet, which is automatically generated according to a system instruction, to a virtual pet server, and display the data returned by the virtual pet server, in which the data may be the natural language response sentence of the second virtual pet, or in other words, the natural language chatting response sentence of the second virtual pet.

The virtual pet data maintaining unit includes a pet attribute library and the virtual pet server, the pet attribute library saves information, such as pet attributes, pet master attributes, and pet property attributes, etc, the virtual pet server is configured to read or modify the information in the pet attribute library, forward the chatting initiation sentence sent by the virtual pet client to a virtual pet questioning and answering server, and return the chatting response sentence obtained after processing by the virtual pet questioning and answering server to the virtual pet client.

The questioning and answering unit may be the virtual pet questioning and answering server, which includes a knowledge library, the virtual pet questioning and answering server is configured to perform the natural language understanding for the chatting initiation sentence sent by the virtual pet server, perform the reasoning taking into account the attributes of the virtual pet, and generate the natural language chatting response sentence for another virtual pet, e.g., for the second virtual pet.

Preferably, at least one communication platform is included between the virtual pet client and the virtual pet server. The communication platform is configured to transmit information between the virtual pet client and the virtual pet server.

Furthermore, a distributing server is included between the communication platform and the virtual pet server. The distributing server is configured to connect with multiple groups of virtual pet servers as well as the questioning and answering servers, and allocate data sent from the communication platform equally to each group of the virtual pet server and the questioning and answering server for processing.

Meanwhile, another embodiment of the present invention provides a virtual pet chatting method, including:
sending, by a first virtual pet, a natural language chatting initiation sentence, e.g., a natural language question, to a second virtual pet; and
generating, by the second virtual pet, a natural language chatting response sentence, e.g., a natural language response sentence, according to the natural language chatting initiation sentence, after performing natural language understanding and reasoning taking into account attributes of a virtual pet.

With the virtual pet chatting system, method as well as the virtual pet questioning and answering server provided by embodiments of the present invention, the intelligent questioning and answering as well as the dialogs in the form of the natural language may be performed among the multiple pets fed by the pet master or among the pets fed by the pet master and the pets fed by other contacts. The user may obtain recreational experience by watching the automatic dialogs among the pets. Compared with that obtained by watching the set or invariable dialogs, the experience is more flexible and interesting. The knowledge degree between the pets and the pet masters is deepened through the dialogs among the pets. The pet masters may also get to know new internet friends and those with the same interests through feeding the virtual pets.

### BRIEF DESCRIPTION OF THE DRAWINGS

FIG. 1 is a schematic diagram illustrating connection of functional units in a virtual pet chatting system in accordance with an embodiment of the present invention.

FIG. 2 is a schematic diagram illustrating structure of a virtual pet chatting system in accordance with a first embodiment of the present invention.

FIG. 3 is a schematic diagram illustrating structure of a virtual pet chatting system in accordance with a second embodiment of the present invention.

FIG. 4 is a flow chart illustrating a virtual pet chatting method in accordance with a third embodiment of the present invention.

FIG. 5 is a flow chart illustrating a virtual pet chatting method in accordance with a fourth embodiment of the present invention.

### EMBODIMENTS OF THE INVENTION

The present invention is further described in detail hereinafter with reference to the accompanying drawings and embodiments to make the objective and technical solution thereof more apparent. It should be understood that the embodiments are only used for explaining the present invention, not used for limiting the protection scope thereof.

The virtual pet chatting system and method provided by embodiments of the present invention, through transmitting and processing questioning and answering sentences for at least two pet clients, may make a user experience conversations using the natural language among the virtual pets when the user playing a virtual pet game.

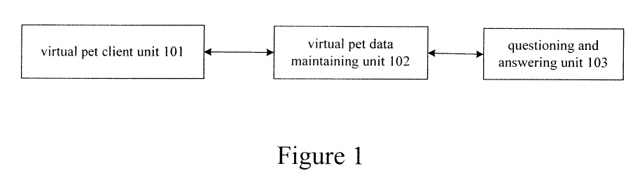

Referring to FIG. 1, FIG. 1 is a schematic diagram illustrating connection of functional units in a virtual pet chatting system in accordance with an embodiment of the present invention.

The system includes a virtual pet client unit 101, a virtual pet data maintaining unit 102 as well as a questioning and answering unit 103.

The virtual pet client unit 101 is configured to receive operations, such as, feeding, bathing and playing, etc., performed by a user for a virtual pet and display behavior and reflection, such as, happy, sad or taking exercise, of the virtual pet. The virtual pet client unit 101, which connects with the virtual pet data maintaining unit 102, is configured to send the received operation data performed by the user for the virtual pet and/or a chatting initiation sentence automatically generated according to system instructions to the virtual pet data maintaining unit 102, and configured to display data returned by the virtual pet data maintaining unit 102 on the client.

The virtual pet data maintaining unit 102 is configured to store and manage some characteristics of the virtual pet, such as, pet attributes, pet master attributes and pet properties, etc. The virtual pet data maintaining unit 102, which connects with the virtual pet client unit 101 as well as the questioning and answering unit 103, is configured to forward the chatting initiation sentence sent by the virtual pet client unit 101 to the questioning and answering unit 103, and configured to return a chatting response sentence obtained after processing by the questioning and answering unit 103 to the virtual pet client unit 101.

The questioning and answering unit 103 is configured to respond to a natural language question put forward by a virtual pet when the virtual pets are chatting with each other. The questioning and answering unit 103, which connects with the virtual pet data maintaining unit 102, is configured to perform natural language understanding and reasoning for the chatting initiation sentence sent by the virtual pet data maintaining unit 102, and configured to generate a natural language response sentence for another virtual pet.

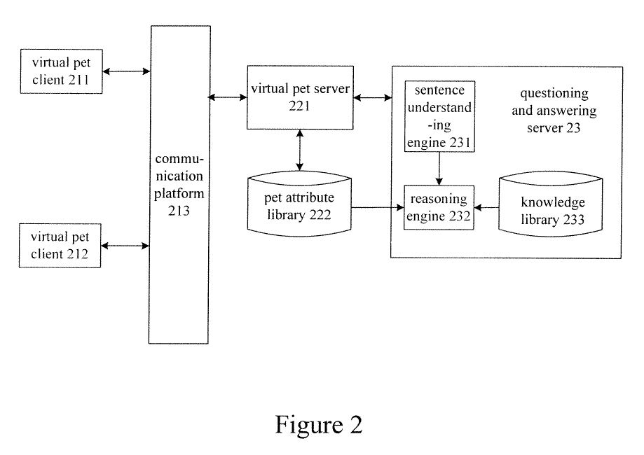

Referring to FIG. 2, FIG. 2 is a schematic diagram illustrating structure of a virtual pet chatting system in accordance with a first embodiment of the present invention. The system structure is applicable to the questioning and answering of the chatting among virtual pets of network users.

The system includes two virtual pet clients 211 and 212. The virtual pet client is a program running a virtual pet game, and may be desktop software or a virtual pet module in a web page. The virtual pet client may be independent of or included in a tool, such as an Instant Messenger.

The system further includes a communication platform 213, such as an Instant Messaging (IM) platform.

The system further includes a virtual pet server 221, which is configured to manage some characteristics of the virtual pet, such as pet attributes, pet master attributes and pet properties, etc. The virtual pet server 221 is further in charge of forwarding chatting initiation sentences sent by the virtual pet clients 211 and 212 to a questioning and answering server, and returning a chatting response sentence obtained after processing by the questioning and answering server to the virtual pet clients 211 and 212.

The system further includes a pet attribute library 222, which is configured to store information, such as the pet attributes, pet master attributes and pet properties in a database or in other forms. The information may be stored in the virtual pet server 221 or in another server. The virtual pet server 221 reads or modifies the information in the pet attribute library 222.

The system further includes a questioning and answering server 23, which is configured to make a response to a natural language question of one virtual pet and generate a natural language response sentence for another virtual net when the virtual pets are chatting with each other.

The questioning and answering server 23 includes a natural language understanding module and a response sentence generating module. Specifically, the natural language understanding module may be a sentence understanding engine 231, the response sentence generating module may be a reasoning engine 232.

The sentence understanding engine 231 is configured to perform natural language understanding processing for an input question.

The reasoning engine 232 is configured to generate the natural language response sentence.

The questioning and answering server 23 further includes a knowledge library 233, which saves a great deal of knowledge needed by the natural language reasoning as well as questioning and answering in the form of questioning and answering sentence pair and adopting a specific format suitable for the reasoning, so as to provide accessing and using for the reasoning engine 232.

The natural language processing performed by the sentence understanding engine 231 includes segmenting a word, extracting a sentence trunk, determining a sentence type, determining a topic, etc. The reasoning engine 232 may call data in the pet attribute library 222. The reasoning engine 232 generates the natural language response sentence corresponding to the natural language question according to information, such as the processing result of the sentence understanding engine 231, the reasoning knowledge saved by the knowledge library 233 as well as the pet attributes and pet master attributes in the pet attribute library 222.

The working principle of the reasoning engine 232 is disclosed with the following embodiments. For instance, specific replacement characters are adopted in the questions and response sentences saved in the knowledge library. When generating the final response, locations of the replacement characters are replaced with data of corresponding attributes. For instance, if the question is “Where is your master studying?”, after processing using the natural language, the question is matched to the corresponding chatting response sentence “My master is studying at $MasterSchool$”, which includes the replacement character $MasterSchool$“. Thus, when generating the final chatting response sentence, location of the replacement character is replaced with corresponding attribute values of the virtual pet master. For instance, value of the ”MasterSchool” attribute (the school at which the master is studying) of the virtual pet master is “Huazhong University of Science and Technology”. Thus, the generated final response is “My master is studying at Huazhong University of Science and Technology”. If value of the “MasterSchool” attribute of the master is null, i.e., the virtual pet master does not submit his/her attribute or the attribute of the virtual pet master can not be obtained with other approaches, another response “I do not know where my master is studying, and I will ask him/her latter” is generated. The attribute values may be information submitted by the user when registering or playing the virtual pet game, or information submitted by the user when registering or using IM software interworking with the virtual pet game. The above descriptions are merely an example of the reasoning procedure. Reasoning functions of the reasoning engine 232 and contents design for the chatting response sentences in this embodiment include, but are not limited to the above descriptions.

The connection relationships among each device in all drawings of the present invention are used for clearly explaining the information questioning and answering as well as the controlling process. Thus, the connection relationships should be understood as logical connection relationships, instead of limiting to physical connection relationships.

In order to meet requirements of mass users, a distributing server may be added between the communication platform 213 and the virtual pet server 221 in practical applications. The distributing server may connect with multiple groups of virtual pet servers 221 as well as questioning and answering servers 23. And the distributing server is configured to ensure load balance of each virtual pet server 221 as well as each questioning and answering server 23.

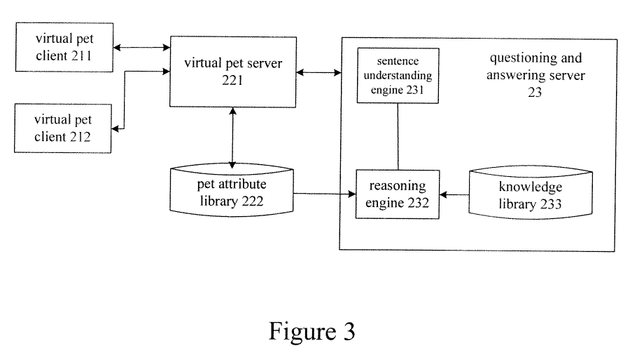

FIG. 3 is a schematic diagram illustrating structure of a virtual pet chatting system in accordance with a second embodiment of the present invention. The system structure is applicable to the questioning and answering during chatting between two virtual pets on a computer.

The system includes two virtual pet clients 211 and 212, a virtual pet server 221 for managing characteristics of virtual pets, a pet attribute library 222 for saving various attributes of the virtual pets. The virtual pet server 221 reads or modifies information in the pet attribute library 222. The system further includes a questioning and answering server 23 for responding to a natural language question and generating a response. The questioning and answering server 23 includes a sentence understanding engine 231, a reasoning engine 232 and a knowledge library 233. Different from the first embodiment, this embodiment does not include a communication platform. User operation data received by the virtual pet clients 211 and 212 is directly transmitted to the virtual pet server 221 without passing through the communication platform. The connection relationships and functions of other parts are similar to those of the first embodiment, thus no further descriptions are provided here.

In the above embodiment, the virtual pet server 221 as well as the questioning and answering server 23 are implemented with hardware. Certainly, they also can be implemented with software functional units.

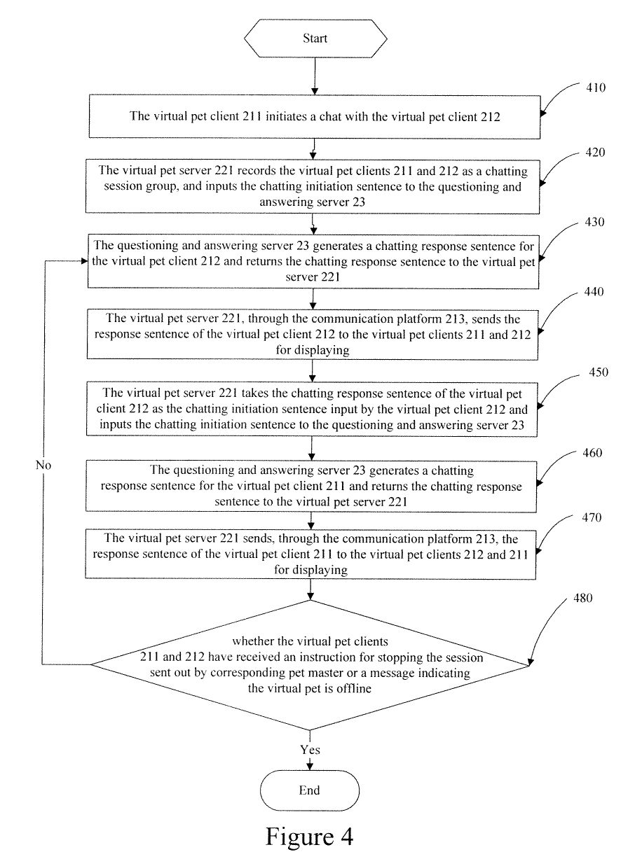

FIG. 4 is a flow chart illustrating a virtual pet chatting method in accordance with a third embodiment of the present invention. The method is based on the system structure in the first embodiment.

In block 410, after learning a virtual pet client 212 is online, a virtual pet client 211 initiates a chatting with the virtual pet client 212.

The pet attribute library 222 includes an attribute term indicating whether the virtual pets are online. When a user opening the virtual pet client to play the game, the attribute value of the term changes from “offline” to “online”. The virtual pet client further includes a sensing unit, configured to read online state attributes of virtual pets in the pet attribute libraries of other clients according to a preset time interval, such as five minutes. If the previous read state is offline, and the current read state is online, the system automatically sends a chatting initiation sentence. The chatting initiation sentence may be a greeting randomly selected, such as “How are you? Has your master fed you?”.

If the virtual pet client is bound to an IM client, one sensing unit may be set in the IM client. The sensing unit may sense and display whether a contact of the user or an online stranger has logged on the virtual pet client. After finding virtual pet of the contact or the online stranger has logged on, the user in the virtual pet game sends a chatting initiation sentence to the virtual pet of the contact or the stranger by imitating identity of the virtual pet fed by himself or herself.

Thus, the chatting initiation sentence may be automatically sent out by the system according to attribute settings, or may be manually sent out by the pet master according to practical situations.

In block 420, after receiving the chatting initiation sentence sent by the virtual pet client 211 and forwarded by the communication platform 213, the virtual pet server 221 records the virtual pet clients 211 and 212 as a chatting session group, and inputs the chatting initiation sentence to the questioning and answering server 23.

The chatting session group saves chatting contents and key parameters of this chatting, such as ID information of the two chatting parties, etc.

In block 430, after receiving the chatting initiation sentence from the virtual pet server 221, the questioning and answering server 23 generates the chatting response sentence for the virtual pet client 212 and returns the chatting response sentence to the virtual pet server 221.

In blocks 440 and 450, the virtual pet server 221, through the communication platform 213, sends the chatting response sentence of the virtual pet client 212 to the virtual pet clients 211 and 212 for displaying. Then, the virtual pet server 221 takes the chatting response sentence of the virtual pet client 212 as the chatting initiation sentence input by the virtual pet client 212, and inputs the chatting initiation sentence to the questioning and answering server 23.

In block 460, after receiving the chatting initiation sentence input by the virtual pet client 212 in block 450, the questioning and answering server 23 generates the chatting response sentence for the virtual pet client 211 and returns the chatting response sentence to the virtual pet server 221.

In block 470, the virtual pet server 221 sends, through the communication platform 213, the chatting response sentence of the virtual pet client 211 to the virtual pet clients 212 and 211 for displaying.

In block 480, determining whether the virtual pet clients 211 and 212 have received an instruction for stopping the session sent out by corresponding pet master or a message indicating that the other virtual pet is offline. If not, proceeding to block 430; otherwise, the system terminates the chatting session.

Preferably, determining whether to terminate the chatting session may also be performed in blocks 410 to 470.

Generating the chatting response sentence by the questioning and answering server 23 mentioned in this method may specifically refer to the following, performing the natural language understanding processing for the input sentence, and generating the natural language chatting response sentence by utilizing the sentence understanding engine 231 and the reasoning engine 232. The questioning and answering server 23 further includes the knowledge library 233, which saves a great deal of knowledge needed by the natural language reasoning as well as questioning and answering in the form of questioning and answering sentence pair and adopting a specific format suitable for the reasoning, to provide accessing and using for the reasoning engine 232.

The natural language processing performed by the sentence understanding engine 231 includes segmenting a word, extracting a sentence trunk, determining a sentence type, determining a topic, etc. The reasoning engine 232 generates the natural language chatting response sentence corresponding to the input question by using information, such as the processing result of the sentence understanding engine 231, the reasoning knowledge saved in the knowledge library 233, pet attributes and pet master attributes. The reasoning engine 232 sends, through the virtual pet server 221, the natural language chatting response sentence to the virtual pet client 211 and/or 212 for displaying.

In the specific implementation of the method, two roles need to be defined in the virtual pet server 221 for the two virtual pets involved in the chatting session. A question and a response of the two virtual pet clients 211 and 212 are taken as a round of questions and answers. Thus, when each round of questions and answers terminates, the roles are exchanged. The response sentence of this round is taken as the question of next round. For instance, in the above flow, the pets fed by the virtual pet client 211 and the virtual pet client 212 are respectively the first virtual pet and the second virtual pet. Firstly, the first virtual pet initiates the chatting session, thus the first virtual pet is the “initiator”. The response generated by the questioning and answering server for the first time is a response generated by imitating the second virtual pet. Now, the second virtual pet is the “responder”. Then, the response of the second virtual pet is taken as the chatting initiation sentence from the second virtual pet in the second round. Thus, in the second round of the questions and answers, the second virtual pet becomes the “initiator”, and the first virtual pet becomes the “responder”. According to this method, the roles of the two pets are kept exchanging, which makes the pets automatically perform intelligent dialogs.

As an example, after learning the second virtual pet is online, the first virtual pet actively sends a chatting initiation sentence: “How are you? Has your master fed you?”. The greeting sentence is randomly selected from the pet attribute library by the system. The second virtual pet makes a response to the chatting initiation sentence “I just have been fed with salmon. It is delicious!”. The response is generated by the questioning and answering server by performing understanding and reasoning for the question and taking into account the second virtual pet has been fed with the salmon not long ago. In this round of questioning and answering, the first virtual pet is the “initiator”, and the second virtual pet is the “responder”.

Subsequently, the first virtual pet says: “You are so lucky! My master is always busying with working. I am still hungry. Wu wu wu . . . ”. The sentence is a response sentence made by the first virtual pet according to the previous response of the second virtual pet. That is, the sentence is generated by performing understanding and reasoning for the previous response “I just have been fed with salmon. It is delicious!” and taking into account the first virtual pet has not been fed for a long time. In the second round of questioning and answering, the second virtual pet is the “initiator”, and the first virtual pet is the “responder”.

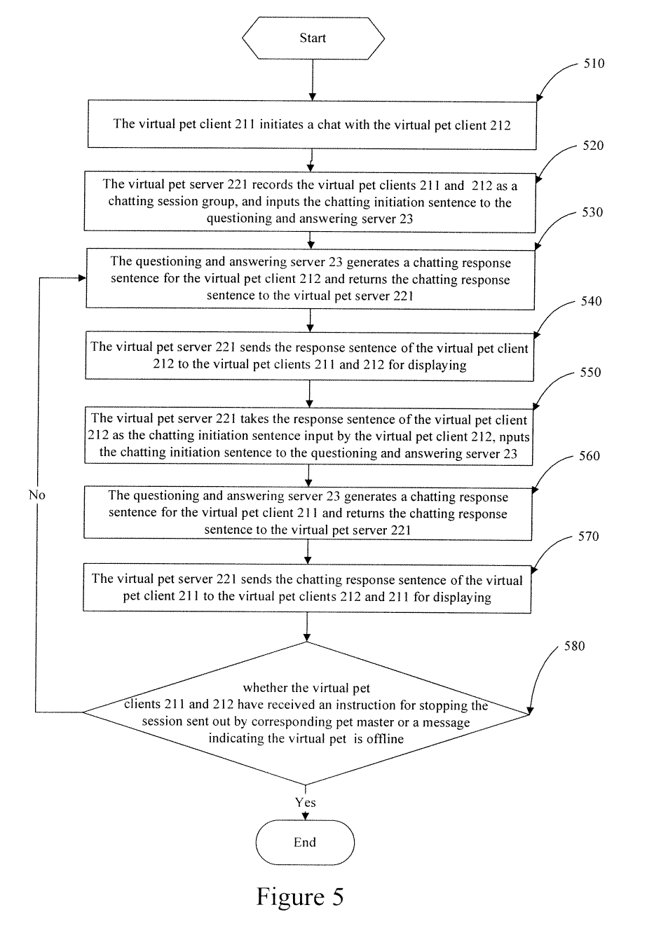

FIG. 5 is a flow chart illustrating a virtual pet chatting method in accordance with a fourth embodiment of the present invention. The method is based on the system structure in the second embodiment.

In block 510, after receiving a chatting initiation sentence input by a pet master, i.e., a user of a virtual pet game, the virtual pet client 211 initiates a chat with the virtual pet client 212, and sends the chatting initiation sentence to the virtual pet server 221.

In block 520, after receiving the chatting initiation sentence from the virtual pet client 211, the virtual pet server 221 records the virtual pet clients 211 and 212 as a chatting session group, and inputs the chatting initiation sentence to the questioning and answering server 23.

In block 530, after receiving the chatting initiation sentence from the virtual pet server 221, the questioning and answering server 23 generates a chatting response sentence for the virtual pet client 212 and returns the chatting response sentence to the virtual pet server 221.

In blocks 540 and 550, the virtual pet server 221 sends the chatting response sentence of the virtual pet client 212 to the virtual pet clients 211 and 212 for displaying. And then, the virtual pet server 221 takes the chatting response sentence of the virtual pet client 212 as the chatting initiation sentence input by the virtual pet client 212, inputs the chatting initiation sentence to the questioning and answering server 23.

In block 560, after receiving the chatting initiation sentence input by the virtual pet client 212 in the above block, the questioning and answering server 23 generates a chatting response sentence for the virtual pet client 211 and returns the chatting response sentence to the virtual pet server 221.

In block 570, the virtual pet server 221 sends the chatting response sentence of the virtual pet client 211 to the virtual pet clients 211 and 212 for displaying.

In block 580, determining whether the virtual pet clients 211 and 212 have received an instruction sent out by corresponding pet master for stopping the dialog or a message indicating that the other virtual pet is offline. If not, proceeding to block 530; otherwise, the system terminates the chatting session.

Preferably, determining whether to terminate the chatting session may also be performed in blocks 510 to 570.

In this embodiment, the questioning and answering server 23 also performs the natural language understanding processing for the input sentence by using the sentence understanding engine 231 and the reasoning engine 232, and generates the natural language chatting response sentence. The specific implementation mode is similar to that in the third embodiment, which will not be described here.

The foregoing is only preferred embodiments of the present invention, which is not used for limiting the present invention. Any modifications, equivalent subsitutions or improvement within the spirit or principle of the present invention should be covered by the protection scope of the present invention.

1. A virtual pet questioning and answering server, comprising:
a natural language understanding module, configured to perform understanding processing for a natural language question sent by a first virtual pet, send a processing result; and
a response sentence generating module, configured to receive the processing result from the natural language understanding module, perform reasoning according to the processing result and an attribute of a virtual pet, and generate a natural language response sentence for a second virtual pet.

2. The virtual pet questioning and answering server according to claim 1, wherein the understanding processing performed for the natural language question sent by the first virtual pet comprises:
segmenting a word, extracting a sentence trunk, determining a sentence type and determining a topic.

3. The virtual pet questioning and answering server according to claim 1, wherein
the natural language understanding module is a sentence understanding engine; and
the response sentence generating module is a reasoning engine.

4. The virtual pet questioning and answering server according to claim 3, further comprising:
a knowledge library, configured to save a great deal of needed reasoning knowledge used for natural language reasoning as well as questioning and answering, in a form of questioning and answering sentence pair and adopting a specific format suitable for the reasoning, to provide accessing and using for the reasoning engine; and
the reasoning engine is further configured to generate the natural language response sentence for the second virtual pet, according to the processing result sent by the sentence understanding engine, the reasoning knowledge and the attribute of the virtual pet saved in the knowledge library.

5. The virtual pet questioning and answering server according to claim 4, wherein the questioning and answering sentence pair in the knowledge library comprises: a specific relevant field, and the relevant filed is replaced with data of the corresponding attribute of the virtual pet when the reasoning engine generating the natural language response sentence for the second virtual pet.

6. A virtual pet chatting system, comprising: a virtual pet client unit, a virtual pet data maintaining unit and a questioning and answering unit; wherein
the virtual pet client unit, which connects with the virtual pet data maintaining unit, configured to send a natural language question of a first virtual pet to the virtual pet data maintaining unit, and display a natural language response sentence of a second virtual pet returned by the virtual pet data maintaining unit; and
the virtual pet data maintaining unit, which connects with the virtual pet client unit as well as the questioning and answering unit, configured to save and manage attributes of virtual pets, forward the natural language question of the first virtual pet sent by the virtual pet client unit to the questioning and answering unit, and return the natural language response sentence of the second virtual pet which is generated by the questioning and answering unit to the virtual pet client unit; and
the questioning and answering unit, which connects with the virtual pet data maintaining unit, configured to perform natural language understanding and reasoning for the natural language question of the first virtual pet sent by the virtual pet data maintaining unit, and generate the natural language response sentence for the second virtual pet.

7. The virtual pet chatting system according to claim 6, wherein
the virtual pet client unit is a virtual pet client, configured to send received operation information performed by a user for a virtual pet and/or the natural language question of the first virtual pet which is automatically generated according to a system instruction to a virtual pet server, and display the natural language response sentence of the second virtual pet returned by the virtual pet server;
the virtual pet data maintaining unit comprises a pet attribute library and the virtual pet server, information saved by the pet attribute library comprises pet attributes, pet master attributes and pet property attributes, and the virtual pet server is configured to read or modify the information in the pet attribute library, forward the natural language question of the first virtual pet sent by the virtual pet client to a virtual pet questioning and answering server, and return the natural language response sentence of the second virtual pet generated by the virtual pet questioning and answering server to the virtual pet client; and
the questioning and answering unit is the virtual pet questioning and answering server, which comprises a knowledge library, the virtual pet questioning and answering server is configured to perform the natural language understanding for the natural language question of the first virtual pet sent by the virtual pet server, perform the reasoning according to the attributes of the virtual pet, and generate the natural language response sentence for the second virtual pet.

8. The virtual pet chatting system according to claim 7, further comprising:
at least one communication platform between the virtual pet client and the virtual pet server, configured to transmit information between the virtual pet client and the virtual pet server.

9. The virtual pet chatting system according to claim 8, further comprising:
a distributing server between the communication platform and the virtual pet server, configured to connect with multiple groups of virtual pet servers as well as questioning and answering servers, and allocate data sent by the communication platform equally to each group of the virtual pet server as well as the questioning and answering server for processing.

10. A virtual pet chatting method, comprising:
sending, by a first virtual pet, a natural language question to a second virtual pet; and
generating, by the second virtual pet, a natural language response sentence according to the natural language question, after understanding natural language and performing reasoning taking into account attributes of a virtual pet.

11. The virtual pet chatting method according to claim 10, after sending by the first virtual pet the natural language question to the second virtual pet, further comprising:
determining whether a command for terminating a chat, or a message indicating any of the first virtual pet and the second virtual pet is offline has been received;
generating, by the second virtual pet, the natural language response sentence according to the natural language question, after understanding the natural language and performing the reasoning taking into account the attributes of the virtual pet if neither the command nor the message has been received;
otherwise, terminating the chat.

12. The virtual pet chatting method according to claim 11, wherein the first virtual pet is taken as an initiator of the chat, the second virtual pet is taken as a responder of the chat, after generating the natural language response sentence, the method further comprises:
taking the second virtual pet as the initiator of the chat;
taking the first virtual pet as the responder of the chat;
taking the sent out natural language response sentence as the natural language question;
sending the natural language question to the first virtual pet; and
returning to process of determining whether the command for terminating the chat, or the message indicating any of the first virtual pet and the second virtual pet is offline has been received.

13. The virtual pet chatting method according to claim 12, further comprising:
taking the first virtual pet sending out the natural language question and the second virtual pet sending out the natural language response sentence as a chatting session group; and
making a record for the chatting session group.
